(19) United States
(12) Patent Application Publication
(10) Pub. No.: US 2007/0276721 A1
(43) Pub. Date: Nov. 29, 2007

(54) Computer implemented shopping system

(75) Inventor: Michael Rodney Jackson, Springfield, VA (US)

Correspondence Address: MORRISON & FOERSTER LLP, 1650 TYSONS BOULEVARD, SUITE 400, MCLEAN, VA, 22102, US

(73) Assignee: Invelus Communications LLC, Springfield, VA (US)

(21) Appl. No.: 11/798,858

(22) Filed: May 17, 2007

Related U.S. Application Data
(60) Provisional application No. 60/808,116, filed on May 25, 2006.
(60) Provisional application No. 60/897,870, filed on Jan. 29, 2007.

(51) Int. Cl. G07G 1/00; G08B 23/00

(52) U.S. Cl. 705/10; 340/573.1

(57) ABSTRACT

The computer implemented shopping system provides a hypermedia presentation on a user's computing device, e.g., a game console, that has a plurality of objects representing a merchant's items for sale. The system includes a shopper profile stored in a database. The shopper profile represents shopper pertinent information by measuring attributes of personality and demography. A target profile is stored in a database that denotes potential desirability of a given shopping object to a shopper. A hypermedia store may present interactive challenges to a shopper to evoke information about the shopper to build the shopper profile. The hypermedia store presents shopping objects available for purchase that are selected based on the target profile and the shopper profile. The hypermedia store also may complete a transaction in which the user may purchase real-world products or services presented on the user's computing device during the hypermedia presentation.

### BACKGROUND OF THE INVENTION

1. Field of the Invention

The invention is drawn to a computer implemented shopping system capable of presenting hypermedia content to video arcade systems, home computer systems, home video gaming systems, and mobile/portable computing systems.

2. Description of the Related Art

Companies who use the present generation of software systems to offer goods and services for sale, by means of electronic media, fail to efficiently and effectively identify the individual consumers (users) who are most likely to purchase their products. Currently, text-based filtering systems present users with a small number of “desirable” items (target objects), which the system selects from a much larger group of items, which are then presented to users to for electronic purchase. These systems' archaic method of using keywords and phrases associated with target objects, along keywords and phrases associated with the user, to determine which target object will be most “desirable” to the user, has fallen short of industry expectations. Even when the system factors in additional statistical information such as a user's age, gender, geographic location, purchase history, product reviews and ratings, the system is still unable to consistently predict the individual preferences of a particular user for any given set of objects. The practical result of this failure is that companies waste enormous resources targeting users who have very little interest in what they are offering.

To date, electronic filtering systems—used, for example, by web-based retailer Amazon.com and others to make product recommendations to customers—have shown poor performance in converting consumer impressions directly into “click-throughs” and on-line sales. These filtering systems are considered disappointing to all involved in e-commerce, including on-line retailers, advertisers, and customers. Technological limitations are at least partially to blame for the poor performance of existing systems. Low bandwidth connections to the Internet, and slow terminal processing speeds have stymied consumers and retailers alike. The typical HTML, PHP and JAVA website is slow to respond to user commands, has extremely limited display capabilities and makes it very difficult for marketers to mine anything more than the most superficial information about any given user. The ability to mine a broader range of information translates into more accurate product recommendations for users and more revenue for retailers. More straightforward attempts have failed because retailers find consumers resistant to completing long and arduous questionnaires. Thus, businesses have too few points of interaction with users. In turn, retailers make superficial guesses as to a particular user's preferences. In other words, on-line retailers do not know their customers well enough.

Just as relevant to the failure of current filtering systems, is the almost total lack of ability to generate the context within which a potentially desirable object may be understood by a user. “How” something is presented to a customer, is often more important than “what” is being presented. Marketing professionals demonstrate a consistent belief in this principle by spending billions of dollars on television advertising, (and to a lesser extent print advertising) where the rule is almost always “style” (context) over “substance” (information). However, given the current technological limitations of the Internet, coupled with two dimensional, “point-and-click” web-sites, Internet marketers have found that they are incapable of generating the same contextual effects which drive demand for products, as they enjoy in other electronic mediums.

### SUMMARY OF THE INVENTION

A Multi-Spatial Similarity Matrix, according to an embodiment of the invention, is an artificially intelligent software program that may present a variety of interactive content, including products and services for sale, to users within a hypermedia environment. The program may act as a database, communications hub, shopping cart, collaborative filter, and similarity matrix. The program may work over a network, to effectively and efficiently present a steady flow of desired objects to users within a hypermedia environment. And by manipulating the environments within which the objects are experienced, the program also creates and controls the context within which these objects may be understood by the user.

A family of applications written in an object-oriented programming language such as C++, DirectX or the like, may be used to build the system components of the computer implemented shopping system.

Interactive activities, or “challenges” of varying length, size, and complexity, resembling video games, or “advert games” may be embedded throughout a given hypermedia environment. Challenges may take the form of product simulations, in which a user may manipulate and experience a product or service within a virtual environment. During the interaction user may be required to make decisions which may reveal important characteristics of that user's personality. That information is then used to build a detailed profile for the user. Examples of a challenge may include a game in which the user plays a round of golf, where the user is given a choice of celebrity partners. The program may calculate personality attributes of the user based on pre-determined profiles of each potential partner. Through programming choices, the system may calculate that a person choosing to play a round of golf with Bob Hope, for example, will have different preferences than another user choosing to play with Justin Timberlake. The program can quantify those differences and transform that data into a detailed personality profile. Another example of a challenge may be to present the user with the opportunity to test drive a motorcycle (this could be a 3D photo-realistic representation of an actual motorcycle for sale). The user may have options available to customize their experience, including a choice of sound tracks, attire, and location. The program can calculate personality attributes based on predetermined profiles related to each possible choice. In other words, a user selecting hip-hop music, a leather jump suit, and an urban riding environment, will have different personality attributes from a person choosing Willie Nelson tunes, blue jeans, and a ride through a national park. These attributes may then be included in the calculation of the user's personality profile. Virtually an unlimited number of variations on this concept exist. This application is not intended to be limited to the specific examples set forth herein.

An embodiment of the present invention advances the current state of computer shopping systems, sufficiently contextualizing the presentation of products and services, to increase the relevancy of any particular object or idea, found by a user, within the matrix-generated hypermedia environment. The system may replace the current one-dimensional “point and click” universe, increasing conversion rates, rates at which browsers for products and services become buyers. The system may more accurately predict a user's behaviors by analyzing complex behaviors, personality characteristics, and interpersonal relationships.

Consumers now have easy access to high-bandwidth Internet connections at affordable prices. Yet, content for e-commerce sites has lagged behind the capability of the latest hardware available to consumers. Thus, a need exists for e-commerce applications that capitalize on the capability of the newest generation of broadband-enabled, home media centers, which are specifically designed to process and display interactive, multimedia content. It would be desirable to present a computer implemented shopping system with a “turn key” hypermedia software solution with the goal of creating an ever-expanding network of virtual destinations, which allow users to move easily from one destination to another, transfer profile information and preferences, maintain active relationships with other users, and provide a variety of features to facilitate e-commerce between merchants and end users. Specifically, the program may function within a network of Massive Multi-User On-line Destinations designed for video game consoles 118, home media centers, set-top boxes, and personal computers 109.

To this end, a present embodiment of the invention is a computer implemented shopping system capable of delivering dynamic audio-visual presentations to a user. The presentations may include virtual environments with one or more shopping objects. Shopping objects may represent a merchant's items, be they products or services for sale. The present invention may be interoperable with an unlimited number of variations, customized for major retailers, advertisers, and media companies.

Each publication may possess a wealth of opportunities for users to purchase products, services, and subscriptions without exiting the hypermedia environment. The system may allow users to select an object from a group of objects within the dynamic audio-visual presentation such that the presentation is uninterrupted. In addition, the system may respond to a user selection of the object by relaying information about the product and further modifying other aspects of the system in accordance with a user's action. Finally the system may be capable of completing a sales transaction, enabling the user to purchase the product presented on the user's computer.

Thus, according to an embodiment of the invention, a system includes at least one shopper profile stored in a database, the shopper profile representing shopper-pertinent information by measuring attributes of personality and demography, at least one target profile stored in a database, the target profile denoting potential desirability of a given shopping object to a shopper and a hypermedia store presenting interactive challenges to evoke information about a shopper to build the shopper profile and presenting shopping objects available for purchase that are selected based on the target profile and the shopper profile.

According to another embodiment, the shopper profile may be modified in accordance with purchases made or shopping objects reviewed through the hypermedia store.

According to yet another embodiment, the target profile may be modified in accordance with shopper activity, where the shopper activity includes at least one of reviewing a shopping object and purchasing a shopping object.

According to a further embodiment, a virtual shopping cart for storing information pertaining to shopping objects selected from the hypermedia store may also be included.

In yet a further embodiment, the hypermedia store may present dynamically layered graphical menus using media objects to provide information displays and navigable links to additional menus, displays, or files. The hypermedia store may be a computer program embedded in a computer-readable medium, where the computer program provides seamless real-time interactivity to facilitate e-commerce in a hypermedia environment. The computer program may include at least one of virtual sales personnel and product demonstrations.

According to another embodiment, the interactive challenges are video games designed to determine personality characteristics of a game player.

According to another embodiment, a browser for browsing the hypermedia store may be provided.

According to another embodiment, the shopper profile includes a numerical code that measures a relationship between content of the hypermedia store and a shopper, where each digit of the numerical code is a measure of a specific shopper attribute. The shopper attributes may be divided into demographic information and dimensions of personality. The shopper attributes may be measured on a scale of 0 to 9.

According to yet another embodiment, a structural profile may be stored in a database. The structural profile may contain objects that represent an environment of the hypermedia store and how the user has modified the environment for use. The structural profile may be modified in accordance to at least one of the shopper profile and the target profile.

According to another embodiment, contextual profile storing contextual objects which represent visual and audio of the hypermedia store environment may be stored. The contextual profile may be modified in accordance with at least one of the shopper profile and the target profile.

### BRIEF DESCRIPTION OF THE DRAWINGS

FIG. 1A is a diagram of a server-client system according to an embodiment of the invention.

FIG. 1B is a diagram of the matrix network according to an embodiment of the invention.

FIG. 2 is a process diagram detailing shopping in a hypermedia environment according to an embodiment of the invention.

FIG. 3 illustrates server components and a link through the Internet to client components, according to an embodiment of the invention.

FIG. 4A is a diagram illustrates how users can purchase the hypermedia catalogs, how updates of certain elements of the catalogs are transferred to the users, and how financial transactions are verified, according to an embodiment of the invention.

FIG. 4B shows a series of columns and rows organized by business element and the fields that are included in each business element, according to an embodiment of the invention.

FIG. 4C is a series of columns and rows organized by business element and the fields comprising each business element, according to an embodiment of the invention.

FIG. 4D is a block diagram displaying the process of hypermedia shopping from user login through checkout, according to an embodiment of the invention.

FIG. 5 shows a screen shot of the homepage of a store in the hypermedia catalog, including the merchant's logo and access point for the system, according to an embodiment of the invention.

FIG. 6 is a homepage screen shot, according to an embodiment of the invention.

FIG. 7A is a screen shot of the user login screen for a hypermedia shopping system, according to an embodiment of the invention.

FIG. 7B is a screen shot displaying what occurs when a user has successfully logged into a hypermedia shopping system, according to an embodiment of the invention.

FIG. 7C is a screen shot showing the transitioning of the frames in a cross-fade that occurs after a user selects from the options “Explore,” “Contact Friends,” and “Review Past Orders,” according to an embodiment of the invention.

FIG. 7D is a screen shot indicating a shopping session is about to begin, according to an embodiment of the invention.

FIG. 7E is a screen shot that shows how the media frames continue uninterrupted during processing time for loading a new hypermedia catalog, according to an embodiment of the invention.

FIG. 7F is a screen shot representing the storefront of a hypermedia store according to an embodiment of the invention.

FIG. 7G is a screen shot showing various areas a user may choose to enter once the user has entered the virtual store, according to an embodiment of the invention.

FIG. 7H is a screen shot of various clothing items, or shopping objects, according to an embodiment of the invention.

FIG. 7I is a screen shot that shows a single shopping element in greater detail, including the price and description of the item, according to an embodiment of the invention.

FIG. 7J is a screen shot that displays the billing and shipping details that are a part of the shopping cart checkout process, according to an embodiment of the invention.

FIG. 7K is a screen shot of a user's virtual shopping cart containing shopping objects, according to an embodiment of the invention.

FIG. 7L is a screen shot, according to an embodiment of the invention.

### DETAILED DESCRIPTION OF THE INVENTION

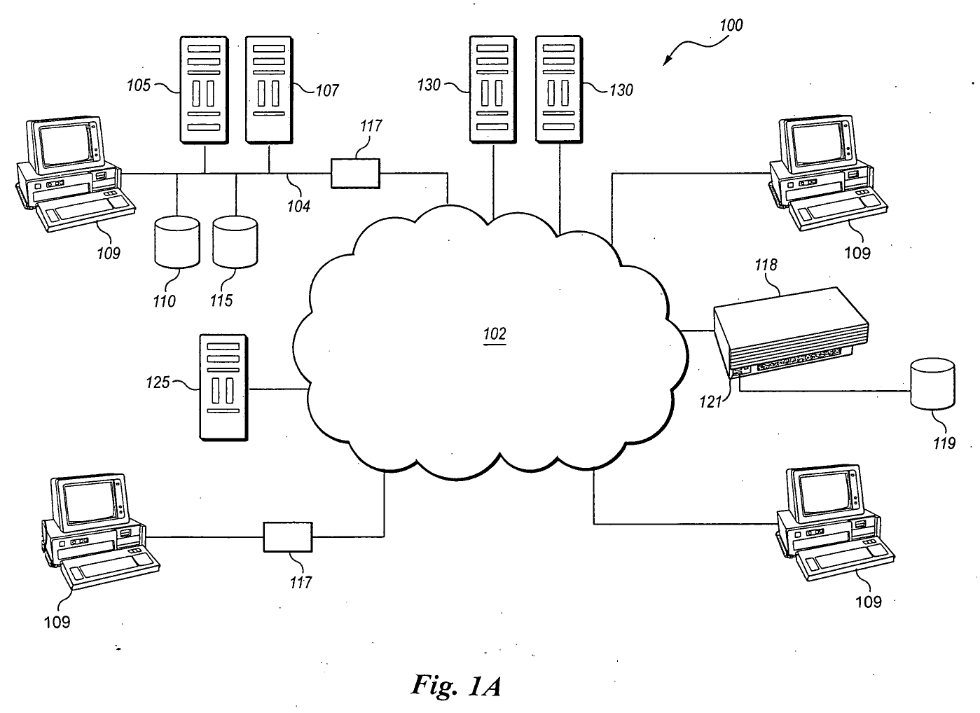

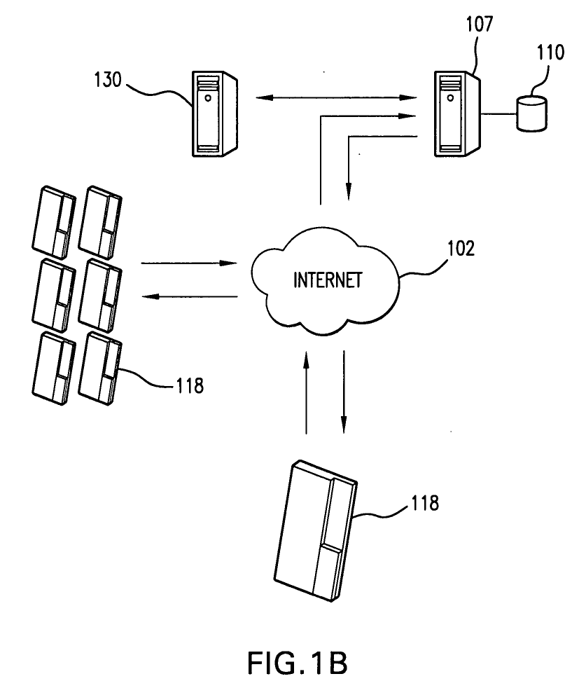

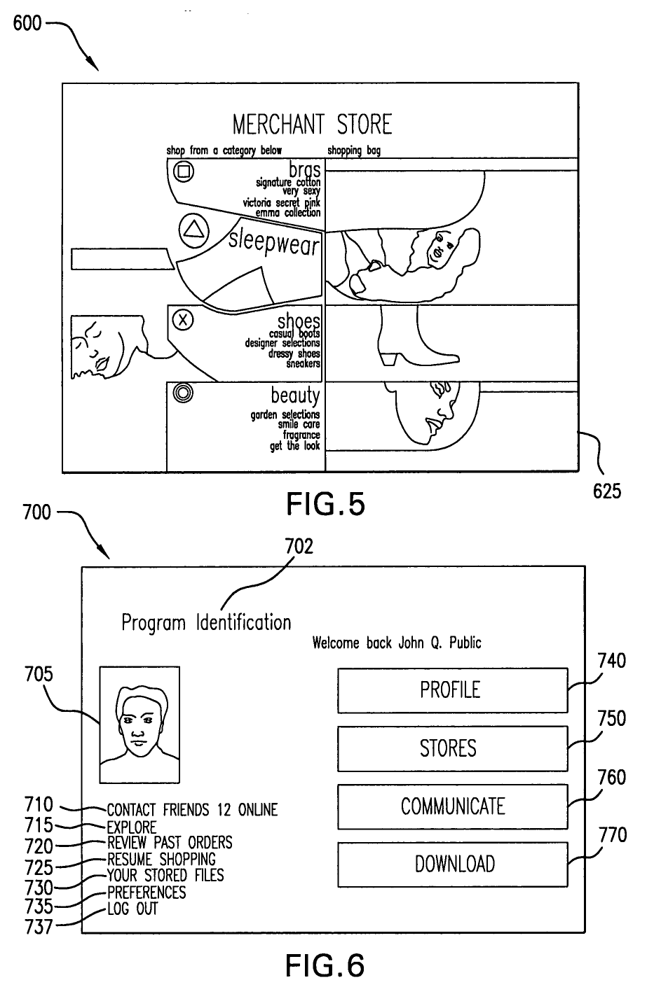

Referring to FIGS. 1A and 5, an embodiment of the invention provides a highly interactive presentation in which a user may browse and purchase merchandise and services through a computer implemented system 100 that may have dynamically layered graphical menus. For example, graphical menus may be structured according to conceptual groupings based on predetermined event sequences. Those predetermined event sequences can be frames that incorporate media objects. Media objects are, for example, video clips or digital animation. The video digital animation, in turn, may contain shopping objects. Shopping objects are products or services that a shopper may purchase through the hypermedia environment.

Referring to FIGS. 1B and 6, according to one embodiment of the invention, a user may install a store or catalog to the console hard drive via portable storage device or download it from application server 105. Software will automatically search for the matrix program on the user hard drive. If found, user identification is initiated, then upon confirmation, store is loaded. If not found, the matrix program will be installed locally and a user profile 740 created based on user input. Upon completion of profile, store is loaded. To access additional stores previously loaded onto the user's system, to find additional titles to install, or to access additional tools, the user can activate the matrix program graphical interface 700. Like the store/catalog interfaces, matrix interface is a hypermedia environment including real-time animated graphics, surround sound and video. Through the matrix program, the user can manage all “Matrix Compatible” software and related files. See previously files disclosures for additional capabilities.

Referring to FIG. 1B, an embodiment of the invention provides for a network where information is exchanged between a program stored on a user's computer 109 and a file server 107. The matrix program is installed locally on the user's system 109 where it controls compatible programs. User system 109 represents one of an unlimited number of similarly configured users on the network. The program communicates with the file server 107, in real time, via the Internet, ensuring all data is kept current. The network also allows for the exchange of information that may affect various data sets 132 & 130 and profiles, where the information is shared between all users 109 on the network via the file servers 107. The servers 127 also communicate with 3^{rd} party “merchant” servers 130 to update relevant information 132. Changes made to relevant data sets and profiles are then pushed across the network to all user-relevant user systems 109. Users may also communicate directly with each other using voice and data sent over the Internet 102.

Hypermedia destinations may include, but are not limited to, video, audio, text, graphics, images, animation and holographic representations of various objects. The dynamically layered graphical menus use the media objects to provide information displays and navigable links to additional menus, displays, and files. It should be understood that graphical menus or images may be activated as navigable links, which a user may click on for further action of the system 100. As shown in FIG. 6, an activity management frame 700 may be displayed having service provider indicia in the upper left-hand portion of the screen 702, a user photo ID 705, contact notification 710, an explore button 715, a review past orders button 720, a resume shopping button 725, a stored files access button 730, a preferences button 735, and a logout button 737. A profile button 740 may be provided for user access to the user's profile. Stores button 750 may be provided for access to a list of stores where the user is capable of shopping using the system 100. A communicate button 760 may be provided for user communication with contacts, merchants, and the like. A download button 770 may be provided for users to download partial updates (for example, software updates and catalog updates) from the file server 107 (shown in FIG. 1A).

The present invention is designed to maximize networking and system capabilities. As shown in FIG. 1A, the shopping system 100 may have a plurality of servers, including an application server 105 and a file server 107 that may run system applications and deliver hypermedia content to users' systems 109. The users' systems may be a gaming console (as shown at element 118 in FIG. 1A), a personal computer, or an organization computer. In addition, the application server 105 may be in operational communication with a plurality of merchant servers 130.

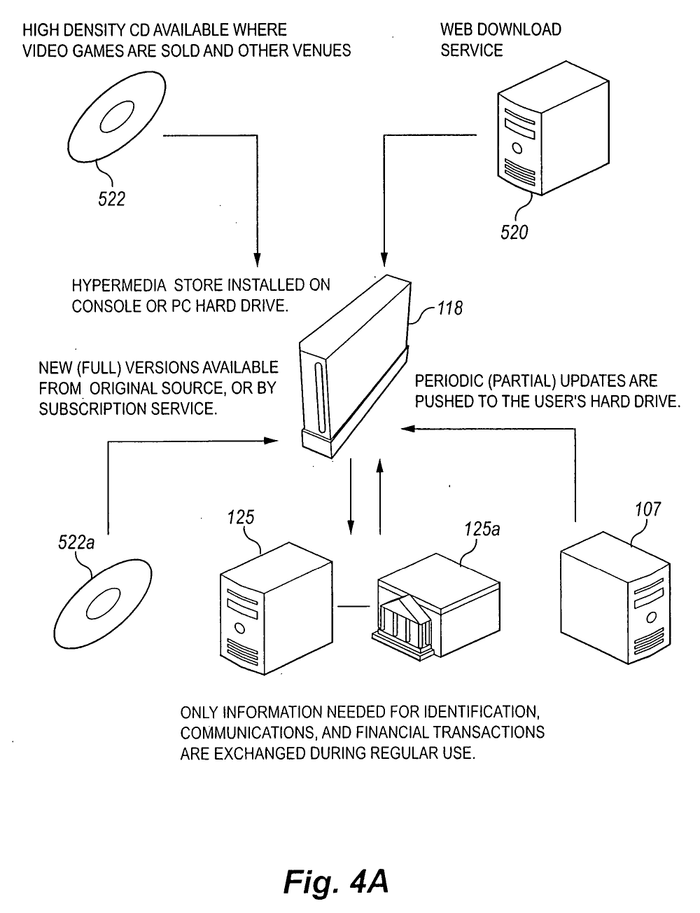

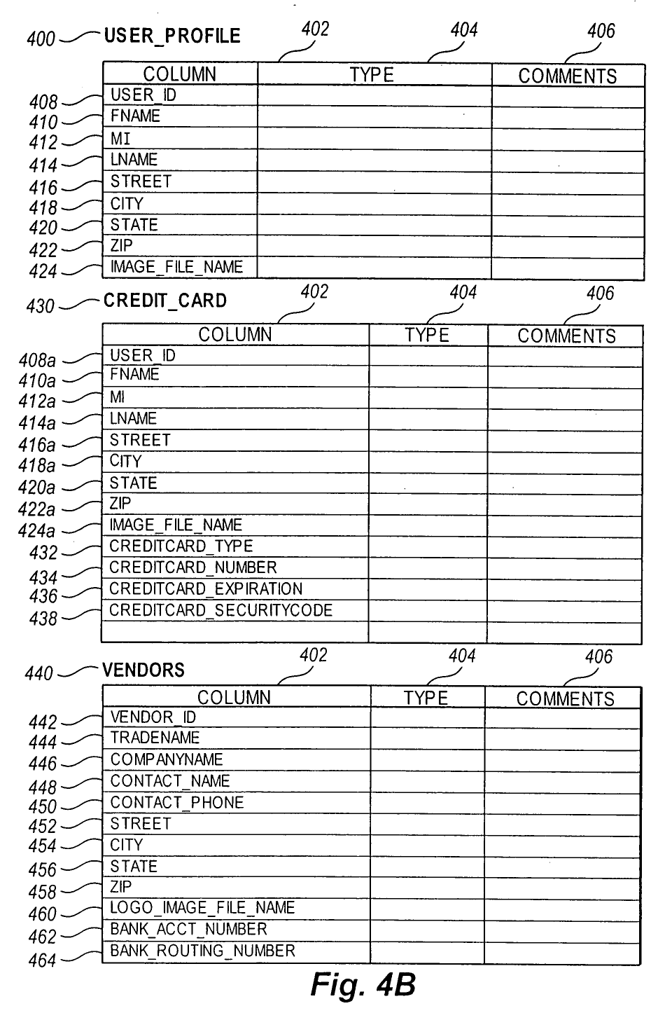

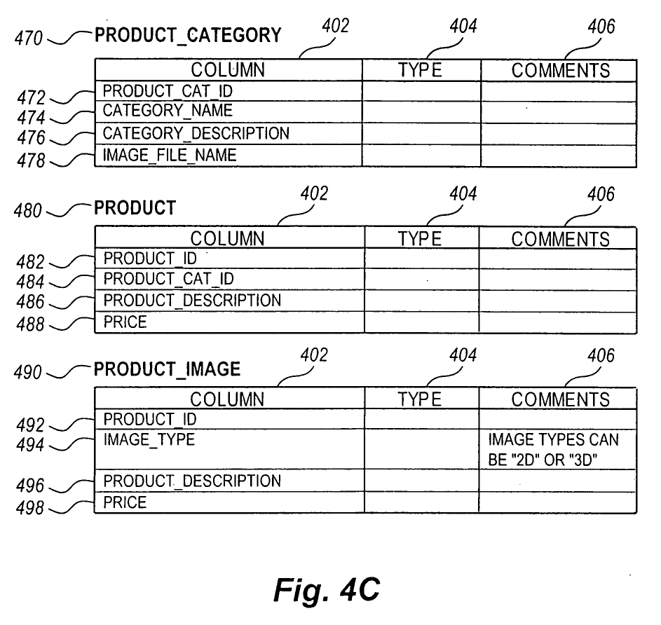

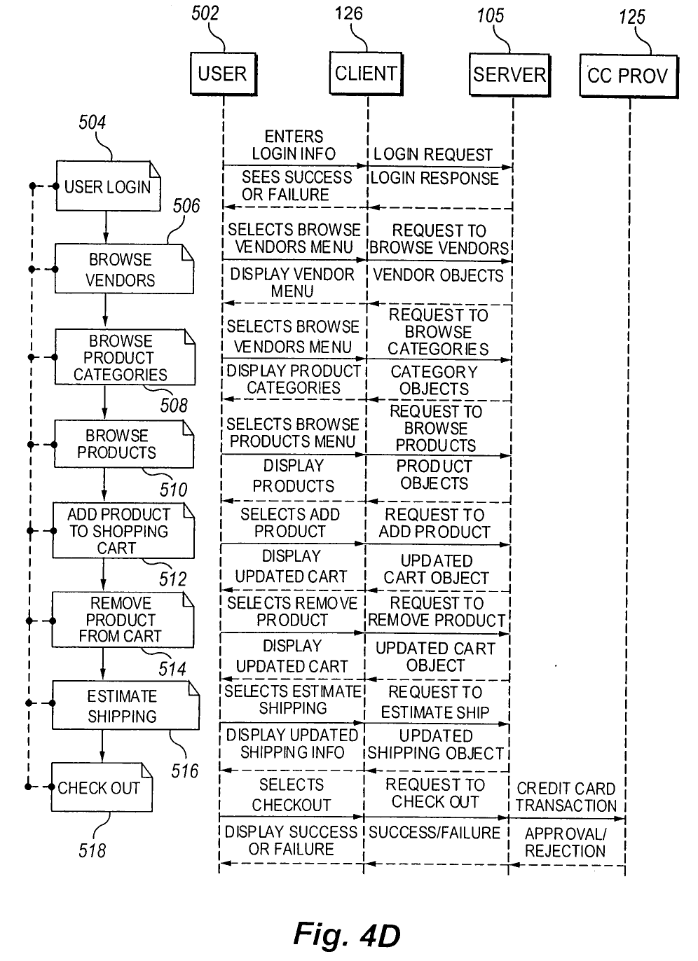

As shown in FIGS. 1 and 4D, on the client side, an embodiment of the present invention may be a shopping system 100 compatible with users' systems 109. The user's system may be a high-speed web-enabled computer capable of broadband communication on line 104, multimedia presentations, and reception of live television and video on demand. The user 502 may employ a variety of devices, including but not limited to, a keyboard, mouse, joystick controller 334, steering controller, pointing device, touchpad, and light-tracking device. In particular, as shown in FIG. 1A, the game console 118 may have a I/O (input/output) connection to mass storage unit 119 through an I/O port such as USB port 121 in order to provide sufficient capacity to run client software associated with the system 100. User computing devices may be operable with the system 100 through a direct connection to the Internet 102 or via a protective firewall, such as firewall 117.

The user 502 may select a separately presented dynamic menu or a menu represented by a media object. The user 502 may click on or otherwise select a separately presented dynamic menu that may include menu items. Or in some cases, the dynamic menu may be represented by one of the media objects, for example, a loop of a specific video sequence depicting either dynamic action or alternatively still images 620. The present invention may also be operable with cable and satellite television terminals, digital video recorders, and the like.

As shown in the embodiment in FIG. 4A, a user can obtain software-enabled catalogs by downloading them from a World Wide Web download service 520 of the system, or through high-density CD 522, or other physical storage media, which may be DVDs or memory sticks. The high-density CD 522 containing these hypermedia catalogs may be sold where video games are for sale or in other venues. Hypermedia catalogs also may be available for download to the hard drive 127 of the user device 109, which may include, but is not limited to, a console or PC hard drive through a World Wide Web download service 520. New full versions 522a of the catalog may be obtainable from an original source or by subscription from the service provider of the computer implemented system. The catalog may publish updates from the file server 107 continually or publish them weekly, monthly, semi-monthly, or annually. Financial transaction information may be exchanged with the user system 109 through operable communication with an account server of the user's financial institution 125a. In addition, the financial transaction information may be verified with the user's credit card service provider server 125.

In addition, original interactive entertainment designed around a particular brand of product may be provided while presenting the brand of product for sale in an e-commerce setting. Moreover, real-time interaction with other users utilizing the computer implemented shopping system 100 of the present invention may be provided. Thus, an expanding network of on-line relationships with various users and merchants may be maintained, while easy transfer of user profile information among a variety of merchants may be facilitated when a user makes a purchase.

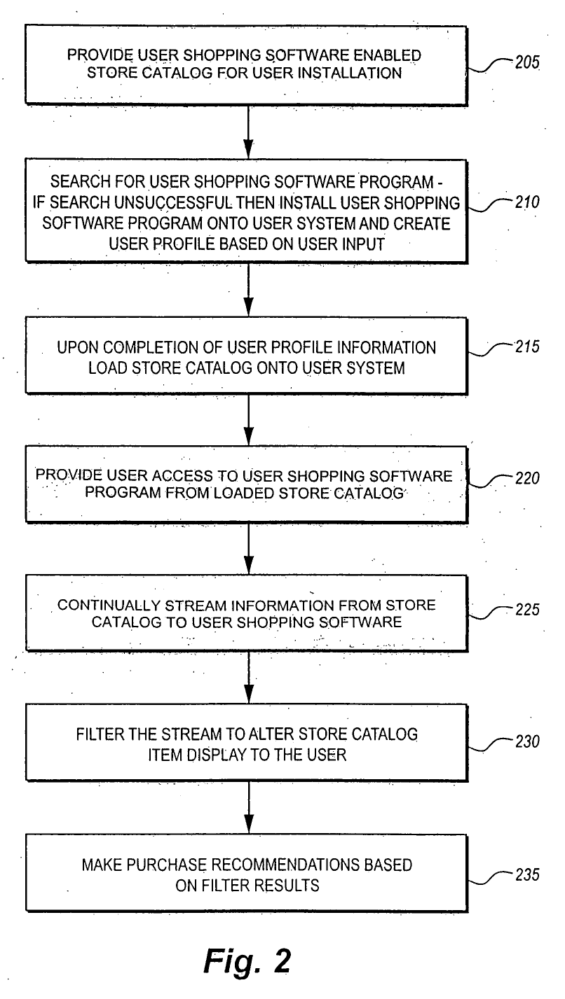

System installation is a straight-forward process. According to an embodiment of the present invention as shown in FIG. 2 at 205, at least one hypermedia catalog enabled with client software is provided for user system installation. As shown at 210, prior to installation, a search may determine whether the user has the requisite client software for the computer implemented shopping system 100. The software installs automatically when required. A user profile may be generated based on user input, and the user may obtain a login to the system after inputting personal information. A base shopper profile can be created for the user based on that information. The store catalog subsequently has the capability of being loaded onto the user computer 109 as shown at 215. As shown at 215, once installed, the user is given access to the shopping software program from a loaded store catalog at 220. Information may continually stream from the store catalog to the client software at 225. Additionally, as shown in 230, the streaming data may be altered for display according to user preferences. As shown at 235, the system may make purchase recommendations to the user based in part on the shopper profile.

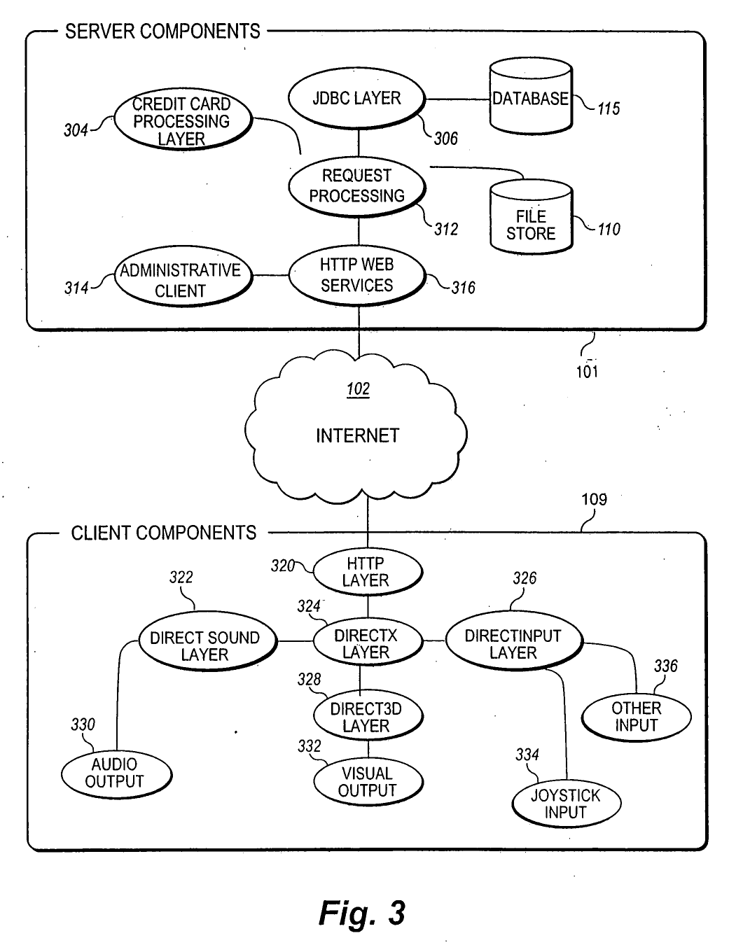

The server components 101 may include, but are not limited to, a file store 110 that permits retrieval of system 100 information, a database 115, and connectivity layers that may include the Java database connectivity (JDBC) layer 306 in FIG. 3. In an embodiment of the present invention as shown in FIGS. 1 and 3, a file store 110 permits retrieval of system 100 information, which may be capable of enabling the user to interact with connected groups of text, graphics, audio, and video. The retrieval system resides in file server 107 with a database 115 and a file store 110. The database 115 can be operably connected to the Internet 102 through an application programming interface (API), which may be a JDBC layer 306. A JDBC layer 306 is connected to a request processor 312. The request processor 312 has access to a file store 110 and a credit card processing layer 304. The request processor 312 is connected to an HTTP World Wide Web server 316, connecting the server components 105 and 107 to the Internet 102. The web server is supported by an administrative client 314.

Client-side operations involve, but are not limited to, connectivity layers, user interfaces, and user peripheral devices to enhance the user's experience. Referring again to FIGS. 1 and 3, on the client side 109, a user's computer can be, for example, a game console 118 that runs client software, retrieving hypermedia through a hypertext transfer protocol (HTTP) layer in communication with the Internet 102. It will be understood that such a game console has a hard drive or other such storage medium for storing data and programs. In any type of user's computing device 109, the HTTP layer 320 also may communicate with, preferably, a DIRECTX layer 324. The DIRECTX layer 324 may facilitate presentation of graphic objects, sound objects, video, animation, and streaming objects to the user. In addition, the DIRECTX layer 324 provides an operable interface through the DIRECTINPUT layer 326, employing a keyboard, mouse, joystick input 334, and/or other game controllers 336 that may be attached as peripheral devices to the user's computing device 109. Three-dimensional (3D) video and graphic renderings are provided through a DIRECT3D layer 328 established between a user's visual output device 332 and the DIRECTX layer 324. DIRECTX 324 operably communicates with a DIRECTSOUND layer 322. A user's audio output 330 is provided through the DIRECTSOUND layer 322.

As shown in FIGS. 4B and 4C, a database structure that may underlie the hypermedia catalog has several tables as follows: user profile, credit card, vendors, product category, product, and product image. These table names reference business objects. For example, these may include a USER-PROFILE table 400, CREDIT-CARD table 430, VENDORS table 440, PRODUCT-CATEGORY table 470, PRODUCT table 480, and PRODUCT-IMAGE table 490, each table may have R rows by C columns. Within the tables, the field names reference business elements, of which, USER-ID, FNAME, and MI fields are examples of business elements. Some of the fields are mandatory because they establish a link between an order and their profile or their order. Without these mandatory fields, the integrity of the information stored would be suspect. Other fields are optional. For instance, not all users will live in apartments. Therefore, the optional nature of the field allows a user to input information like apartment numbers that may be applicable in one instance but not in another.

Underlying the embodiment is a framework for capturing the user's pertinent information to build a shopper profile that will expand the base shopper profile created when the user first sets up an account and obtains a login. As shown in FIGS. 4B and 4C, three columns may be displayed: a first column 402 indicating the name of the column, a type column 404 indicating whether inputting entry into the column is mandatory or optional in nature, and comments column 406. The USER-PROFILE table 400 may have a USER-ID field 408, a FNAME (first name) field 410, a MI (middle initial) field 412, a LNAME (last name) field 414, a STREET field 416, a CITY field 418, a STATE field 420, a ZIP field 422, and an IMAGE-FILE-NAME field 424. Similarly, the CREDIT-CARD table 430 may have fields 408a through 424a having the same field identifiers as fields 408 through 424 in the USER-PROFILE table 400. However, according to the present invention, a CREDIT-CARD table 430 associated with a USER-PROFILE table 400 may have different values in fields 410a through 424a to provide a variety of billing options to the user, for example, third-party billing. Additional fields in CREDIT-CARD table 430 may be a CREDITCARD-TYPE field 432, a CREDITCARD-NUMBER field 434, a CREDITCARD-EXPIRATION field 436, and a CREDITCARD-SECURITYCODE field 438.

The VENDORS table 440 may have the following fields: a VENDOR-ID field 442, a TRADENAME field 444, a COMPANYNAME field 446, a CONTACT-NAME field 448, a CONTACT-PHONE field 450, a STREET field 452, a CITY field 454, a STATE field 456, a ZIP field 458, a LOGO-IMAGE-FILE-NAME field 460, a BANK-ACCT-NUMBER field 462, and a BANK-ROUTING-NUMBER field 464.

According to FIG. 4C, the PRODUCT-CATEGORY table 470 may have the following fields: a PRODUCT-CAT-ID field 472, a CATEGORY-NAME field 474, a CATEGORY-DESCRIPTION field 476, and an IMAGE-FILE-NAME field 478. The PRODUCT TABLE 480 may have a PRODUCT-ID field 482, a PRODUCT-CAT-ID field 484, a PRODUCT DESCRIPTION field 486, and a PRICE field 488. The PRODUCT-IMAGE table 490 may have a PRODUCT-ID field 492, an IMAGE-TYPE field 494, a PRODUCT-DESCRIPTION field 496 and a PRICE field 498.

As shown in FIG. 4D, the program provides seamless, real-time interactivity between user 502, client 109, application server 105, and credit card service provider server 125. The transactional process involves user login 504, vendor browsing, category browsing, product category browsing, addition or removal of products or services from the shopping cart, and product checkout. The hypermedia presentation contemplates virtual sales personnel and product demonstrations. In this context, hypermedia denotes video content for relating product information, including infomercials, commercials, entertainment, music videos, and interviews.

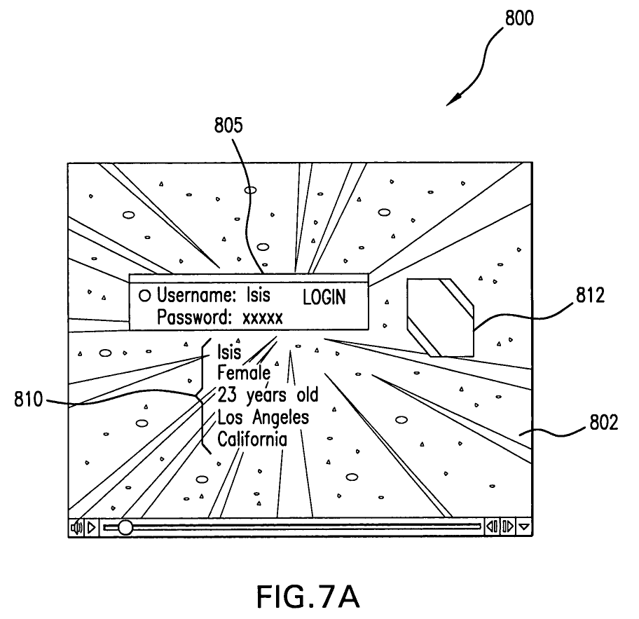

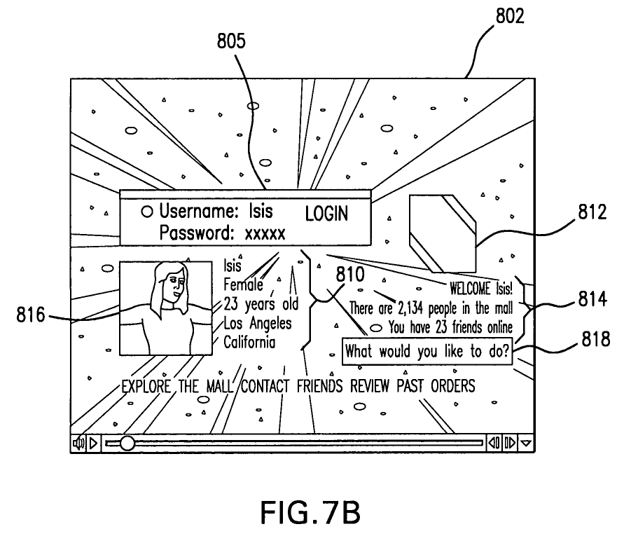

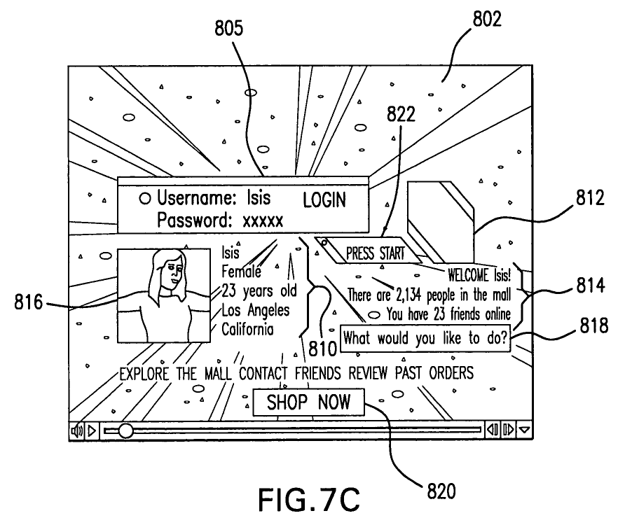

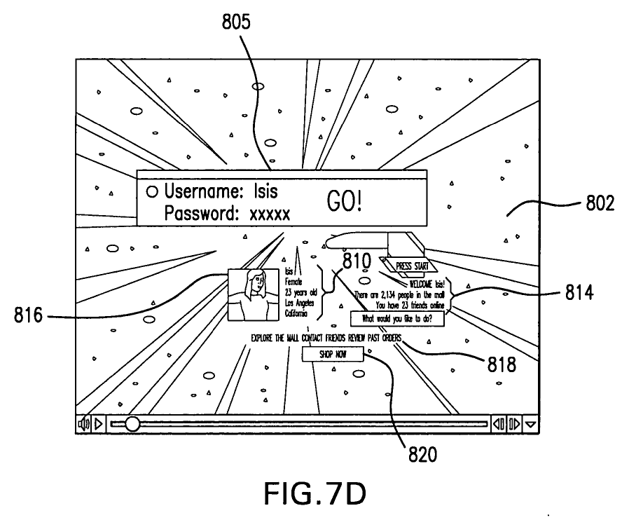

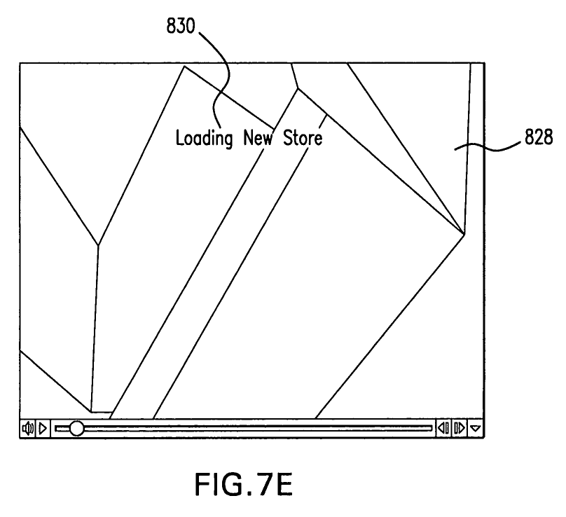

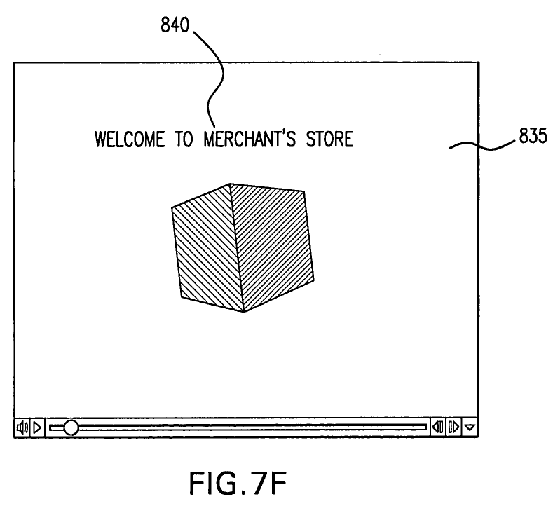

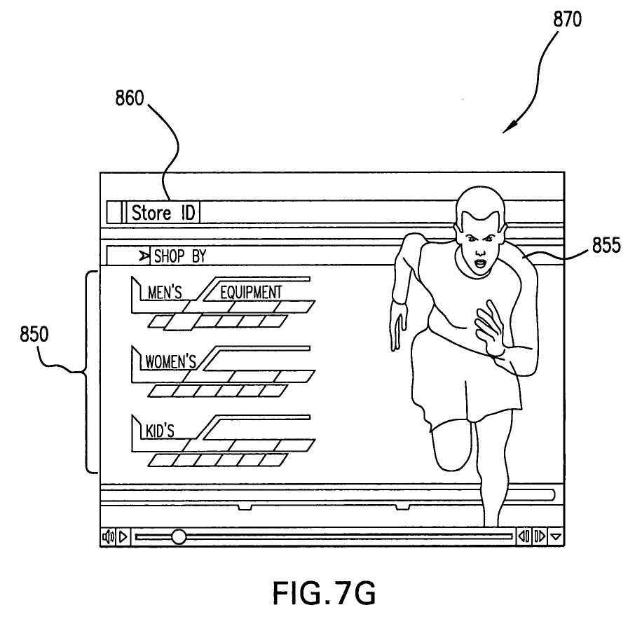

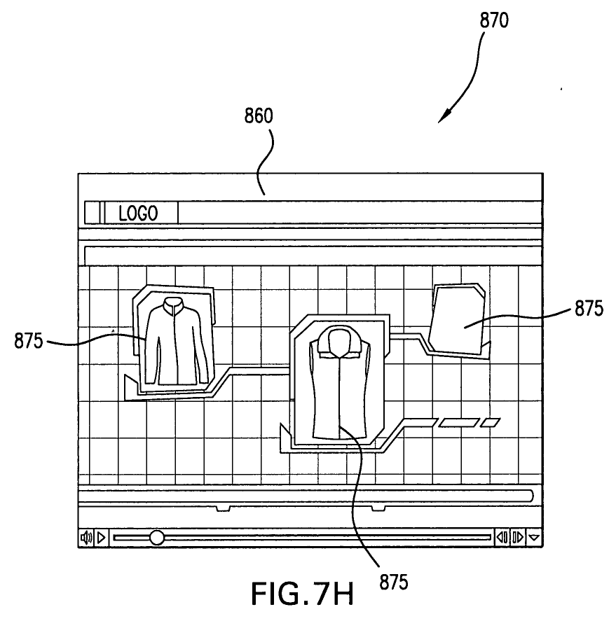

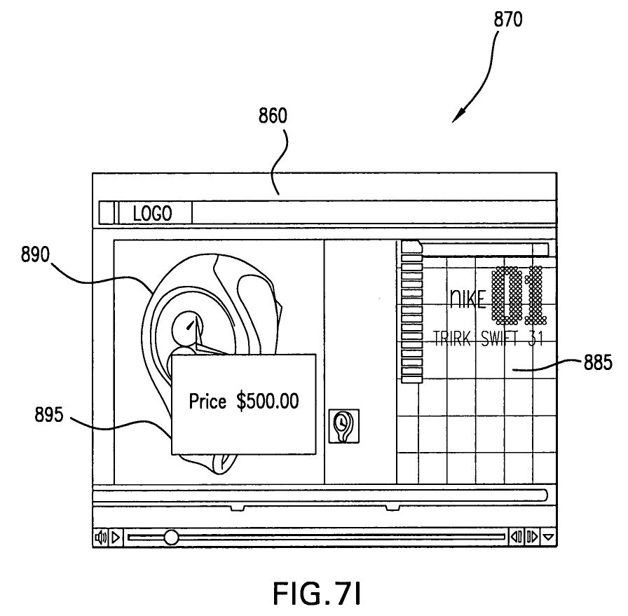

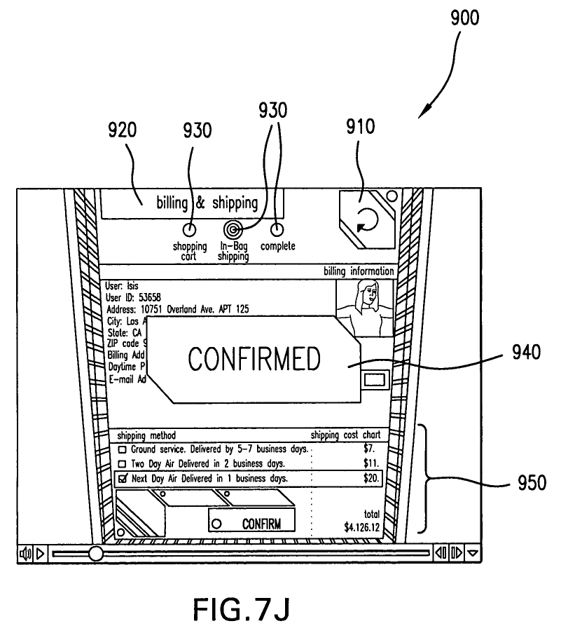

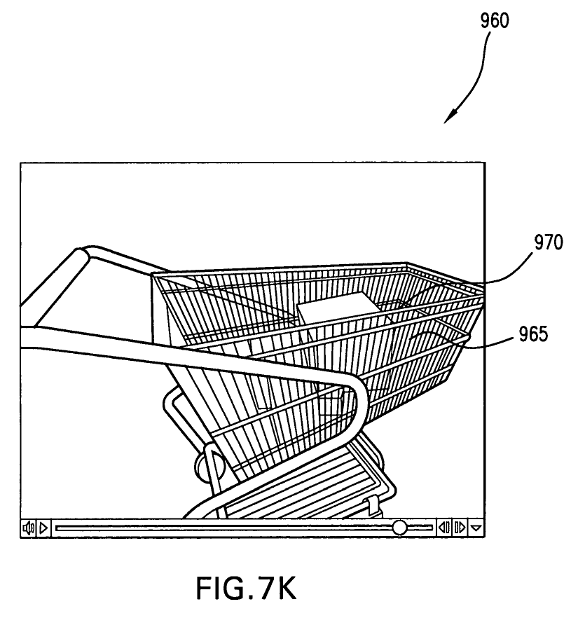

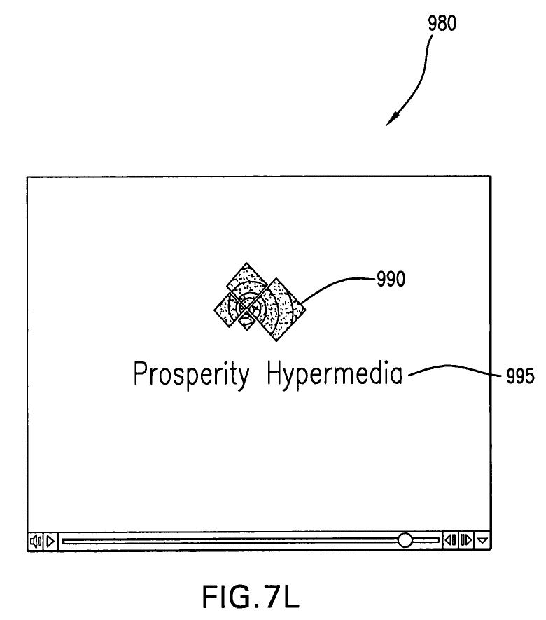

In particular, the user enters a login name and password at 504 and the program performs authentication. The presentation advances to a set of video frames to display additional information, including an information block, user photo ID (see FIG. 6 at 705), and user action prompt fields. The system contemplates visual effects as the presentation transitions. Thus, a cross-fade and an audio effect indicate to the user that a new store is loading. The program also contemplates video and audio transitioning while the user browses vendors at 506, product categories at 508, and products at 510. When a user selects various products or services and a shopping cart progress panel, the system displays purchase price, product description, and merchant logo (see FIG. 7I). A user may click on, tag, or otherwise select the moving product in a motion picture presentation. The shopping system 100 places the object in a virtual shopping cart, at 512, as the video presentation continues seamlessly. The user can remove a product or service from the cart at 514. The user can determine the estimated shipping cost, at 516, prior to checkout, at 518. The process is repeated with the same or different merchants until the user either checks out or terminates shopping.

The present embodiment may be built from a family of applications written in an object-oriented programming language that may be C++, DirectX, or the like. The language may be utilized to build components of a present embodiment of the invention.

Having broadband Internet capability is preferable for running the shopping system because the invention takes full advantage of special hardware and software (graphics accelerators, 3D engines, and high-end video and audio cards) incorporated in video game consoles 118 and home computing systems 109.

A backend infrastructure to support user requirements of the system is contemplated, as is storing and distributing of the hypermedia catalogs.

An embodiment of the invention may have a specialized associated browser 625 for browsing hypermedia catalogs. As shown in FIG. 5, the present embodiment of the invention has a store catalog page 600, product categories (with corresponding still images), and service provider indicia 625. An embodiment of the invention has a browser-like program (computer implemented shopping system browser, or CISSB) functioning as a gateway through which a user may access any compatible store or catalog. The CISSB accesses information about a user's computing resources. The CISSB may be integrated with the shopping software and may be downloadable with the software.

Having a secure transaction and securing access to a user's profile and login capabilities is an important part of maintaining the integrity of the system. Thus, the system 100 contemplates user access from remote locations or in public venues that may include airports or hotels. Thus, the necessity for secure access to information arises. Accordingly, the present invention contemplates employing biometric data scanned from kiosks available at retail outlets. Fingerprint scanners can be integrated into the navigation controller for the system. The scanner, which may have fingerprint pattern analysis capability, may quicken the login interface process, essentially bypassing the need for a password. In addition, fingerprint scanners may be integrated into the navigation controller. The fingerprint scanner may be used to establish identity and provide the customer/user with a secure, easy to use log-in interface that relieves the burden of remembering a password. A charge-coupled device (CCD) imaging scanner or alternatively, a capacitive array scanner may be used to take a light image of a finger pad and analyze a print pattern. The capacitive array scanner may construct a capacitive intensity image that is created by the electrical interaction among the finger pad and its print pattern and a two-dimensional array of small capacitors in the sensor.

The present invention also contemplates compatibility with specialized peripheral devices and controllers 336, webcams, headsets, keyboards, and a credit card reader.

Underlying the present embodiment of the invention is a series of challenges, or games, that contribute to building shopper profiles. In particular, these interactive “challenges,” similar to video games, gauge personality characteristics of individual users. The program numerically expresses these characteristics in a “shopper profile” or “matrix profile.” It then matches the shopper profile with profiles of target objects within the hypermedia catalog the user is currently accessing. Next, the objects may be presented in a context calculated to increase the likelihood a user will make a purchase. A present embodiment of the invention may transform captured user data to create a Companion Profile, designed to anticipate the user's wants and needs. Instead of being static in its responses to a user's needs, the present invention continually learns and anticipates, refining the estimation of a user's wants and needs and thus constantly modifying the shopper profile based on objects purchased, objects reviewed and considered, information gathered from a series of interactive challenges presented to the user, and other relevant pieces of information. Thus, the invention further enhances a unique experience. In addition to modifying the shopper profile as described above, the profiles related to the objects for sale (goods or services) can also constantly evolve to reflect different user activity regarding that object. By immersing the user in a media-rich, multi-dimensional environment (resembling video games), these titles encourage users to “play” in ways that the present embodiment of the system can glean useful information about the user.

Graphical layering in the hypermedia environment enhances the user experience. The present embodiment of the invention may utilize dynamically layered graphical menus (see FIG. 5) structured according to concept groupings. The graphical menus may use media objects, including video, audio, text, graphics, and animation, to provide information displays and navigable links to additional menus, displays, and files. The system may allow users to make purchases from within a multi-dimensional interactive environment. Thus, the elements of the present embodiment of the invention may include a broadband-enabled user computing system and an interactive application, which includes an integrated and dynamic electronic shopping cart that presents a saleable product or service for a user's immediate purchase.

An embodiment of the invention creates a user, or shopper, profile and associated profiles by measuring attributes of demography and personality. An embodiment of the invention may mirror the personality of the user by creating an electronic “alter-ego.” The program associated with the embodiment may work in the background and create a Companion Profile for the user, designed to anticipate all of the user's wants and needs. The program then continually “evolves” the interactive environment to meet those needs by creating a customized environment for the user, resulting in a totally unique experience for every person using the system. The program also may interact directly with the user by generating a personalized virtual representation, including auditory, visual, and tactile elements. This personalized virtual representation also may evolve as the shopper profile and/or the profiles of the target objects evolve.

To create the shopper profile, the program may create a tiered system of related profiles, generating a numerical code that measures the relationship between the content of a hypermedia publication and the user. Each digit may be a measure of specific attributes of the user. In one embodiment of the invention, the attributes are divided into “demographic information” and “dimensions of personality.” The demographic information comes in seven types: sex, age, geographic region, race, religion, language, and children.

Demographic information of users plays a role in determining the shopper profile generated by the system. Seven categories of demographic information may include, but not be limited to:
SX=Sex (1 male, 2 female)
AG=Age (always 2 digit number)
RE=Region (1 MA USA, 2 VA USA, 3 MD USA, etc.)
RC=Race (1 White, 2, Black, 3 Asian, 4 Latino, 5 Mixed Race)
RG−Religion (1 Christian, 2 Muslim, 3 Jewish, 4 Hindu, 5 Catholic, etc.)
LA=Language (1 English, 2, Spanish, 3 Japanese, etc.)
CH=Children (0 no; 1 yes, one child; 2 yes, two children, etc., always two digits, note: ages of children shall be accounted for.)

The personality dimension may have 15 categories, including active/leisurely, conceit/humility, conservative/liberal, conforming rebellious, chaste/sensual, hi-tech/low-tech; solemn/humorous, introvert/extrovert, masculine/feminine, non-religious/religious, rejecting/accepting, risky/careful, scarce/abundant, frugal/extravagant, and thinking/feeling.

Attributes may be measured on a scale of 0 to 9. Zero (0) represents “No Score,” while a five (5) is “Neutral.” When assembled in its final form, the matrix has two parts. The first seven letter pairings represent demographic information. For example, the first part of a profile may be represented as follows: SX AG RE RC RG LA CH. The second part of a profile may be expressed alphabetically using the two (2) characters representing that attributes and represented as follows: AL CH CL CR CS HL SH IE MF NR RA RC SA FE TF.

Dimension of Personality

AL=Active−Leisurely

Measures a user's desire for physical activity.

Assumes an “active” user wants to move.

Fronts active content to “active” users.

Fronts stationary content to “leisurely” users.

CH=Conceit−Humility

Measures vanity of the user.

Assumes “conceited” users will show more interest in distinguishing content.

Fronts distinguishing content to “conceited” users.

Fronts modest content to “humble” users.

CL=Conservative−Liberal

Measures aversion to change.

Assumes “liberal” users will desire new experiences.

Fronts premier content for “liberal” users.

Fronts established content for “conservative” users.

CR=Conforming−Rebellious

Measures a user's tendency to “follow the crowd.”

Assumes rebellious users will be interested in less popular content.

Fronts popular content to “conforming” users.

Fronts alternative content to “rebellious” users.

CS=Chaste−Sensual*

Measures the user's interest in sexuality.

Assumes “sensual” users will have an interest in sexually expressive content.

Fronts sexually expressive content to “sensual” users.

Fronts sexually neutral content to “chaste” users.

*Subject to parental override (Value of 1) for users under the age of 18.

HL=Hi Tech−Low Tech

Measures a person's interest in new technology.

Assumes “hi tech” users are quick to adopt new technology.

Fronts cutting edge tech to “hi tech” users.

Fronts established technologies to “low tech” users.

HS=Solemn−Humorous

Measures a user's interest in humor.

Assumes “solemn” users to be less interested in humor.

Fronts serious content to “solemn” users.

Fronts humorous content to “humorous” users.

IE=Introvert−Extrovert

Measures tendencies to isolate vs. socialize.

Assumes “sociable” individuals prefer to function as part of a group.

Fronts multi-user content for extroverts.

Fronts single-user content for introverts.

MF=Masculine−Feminine*

Measures masculine vs. feminine characteristics of the user.

Assumes “masculine” users will prefer aggressive content.

Fronts aggressive (violent) content to “masculine” users.

Fronts peaceful content to “feminine” users.

*Subject to partial parental override (violent content) for users under the age of 18.

NR=Non-Religious−Religious*

Measures importance of religion (USER RG) to the user.

Assumes “religious” users will want to see more USER RG tagged content.

Fronts USER RG tagged content.

Withdraws USER RG tagged content.

*Subject to parental override (value of 0) for users under the age of 18.

RA=Rejecting−Accepting

Measures external vs. internal modes of control.

Assumes “accepting” users are more readily influenced by others.

Fronts promotional content to “accepting” users.

Fronts informational content to “rejecting” users.

RC=Risky−Careful

Measures the fearfulness of the user.

Assumes “careful” users will prefer safe environments.

Fronts reassuring content to “insecure” users.

Fronts adventurous content to “risky” users.

SA=Scarce−Abundant

Measures a user's need for the conservation of time.

Assumes a “scarce” user wants to shop quickly.

Fronts products for sale.

Withdraws elements not directly related to making a purchase.

FE=Frugal−Extravagant

Measures the importance of saving money to the user.

Assumes “frugal” users are more interested in bargains.

Fronts sale priced items to “frugal” users.

Fronts premium priced items to “extravagant” users.

TF=Thinking−Feeling

Measures a user's need for emotional stimulation.

Assumes a “feeling” user seeks out emotional connections to others.

Fronts human-centric content to “feeling” users.

Fronts logic-centric content to “thinking” users.

Thus, an entire profile may be represented by seven two-letter pairings immediately followed by 15 two-letter pairings: SX AG RE RA RG LA CH AL CH CL CR CS HL HS IE MF NR RA RC SA FE TF.

A unique name may be assigned to each code to ensure accurate processing of the information, for example, “SMJ USER.” A profile code, in its fully expressed form may be a sequence of numbers appearing as follows: (SMJ USER) 1 37 2 5 1 1 03; 4 3 3 6 7 2 4 4 5 7 5 4 3 7 6.

Creating a matrix profile, or shopper profile, requires manipulating and combining associated profiles. There are “Big Profiles,” “Little Profiles,” “Target Profiles,” and one Companion Profile. Little Profiles are categories of interest used to calculate Big Profiles. Little Profiles are organized by how the information is mined from the user. The three Big Profiles (User, Aspirational, and Collaborative) may be used to construct a comprehensive personality profile for the user. The Companion Profile may be created by combining the Big Profiles into a single profile, which then becomes the basis for all decisions the present embodiment of the invention makes about how any given hypermedia publications functions. Target Profiles may be assigned to objects, or ideas, which express the producer's “intended audience” for that particular object or idea. The program may compare the Companion Profile with the Target Profiles found throughout the hypermedia environment and “evolves” the environment to match.

The “User Profile,” also known as the shopper profile, may be the personality profile of the primary user and may be calculated by averaging profile scores from the following categories:
Archetypal Profile—This first profile calculated for new users may be based on the average profile from other users with a similar, or identical, demographic profile.
Challenge Profile—Woven throughout the hypermedia environments may be small interactive programs, resembling games that mine a user's attribute information. Users may freely choose games. Once selected, the program may be capable of directing the action to measure specific user attributes.
“Bought By” Profile—This is an average profile that may be given to individual products or services the user purchases. The hypermedia publications themselves may be assigned a profile (calculated from all of the products and services found within the title). Any publication accessed by a user may be treated as a “purchased product” when calculating that user's profile.

The “Aspirational Profile” or “Want To Be Profile” measures the user's “ideal self.”Scores may be averaged from among the following categories:
Celebrity Profile—The profile may be based on celebrity profiles the user tags. Throughout the hypermedia experience, users may have ample opportunity to express a preference for famous personalities. Each celebrity personality may then be “profiled” during the development process related to their inclusion in the publication. When a user shows preference for a celebrity, that celebrity's profile may be included in the program's calculations like any other product or service.
Fantasy Profile—Users may employ complex avatar building tools to create one or more “virtual selves.” Each avatar may have a profile, a virtual self that may be used during multi-user shopping mode to interact with other users, or to represent their “characters” during challenges. For many users, avatars will include aspirational qualities and represent the user's “ideal self.”

The Collaborative Profile measures how the user relates to the world and is calculated from these Little Profiles:
“Talk To” Profile—Currently one of the most effective filtering programs on the internet is Google's™ Gmail™ system, which “reads” email conversations and makes link recommendations based on what the user is talking about. The program uses the same principles to mine information about users in a collaborative shopping environment. During any on-line conversation, the program “listens” for keywords and phrases associated with personality attributes. Based on this information, the “Talk To” Profile may be calculated and recalculated. The “Talk To Me” is also the only function that can override the Companion Profile and make direct product recommendations to the user. If the program determines that the user is expressing an interest in a particular product, or product category, the program will front available products and services, related to that conversation.
Friend Profile—Average Companion Profile of user's friends. Users may also choose to temporarily adopt another user's Companion Profile as their own. This function will allow users to “see through the eyes” of another user.

The Target Profile denotes the potential desirability of any given object to the user. A team of experts can work closely with retailers, creating this profile based on the intended audience for the object, along with sample information obtained through focus groups and market research. The team may also scan websites, blogs, message boards, and news feeds for further product information that could potentially alter the product profile. With each purchase, the user's Companion Profile is averaged into the original calculation. In time, a Target Profile becomes a Composite Profile of the retailer's intent, consumer input, in addition to characteristics of consumers who purchased the product.

The Companion Profile is calculated as follows:
(3×) USER PROFILE+(2×) ASPIRATIONAL PROFILE+(1×) COLLABORATIVE PROFILE/6

The program may make minor adjustments to this calculation by using the user demographic data (the first seven numbers of a profile) to adjust the weight of the User, Aspirational, and Collaborative Profiles used in the formula. For example, a user who is married with children may have the weight of the Collaborative Profile adjusted down compared with a single user with no children. The program compensates for the notion that single users may be more influenced by friends than married users. Another example would be for older users to have their User Profile weighted up, (or Aspirational weighted down) as one may expect them to have a more “fixed” personality compared with a younger user. Once the formula has been set, the Companion Profile is calculated, and then this represents the actual user in calculating all future similarities.

A key component of this embodiment is the capability and the manner in which the program calculates similarities. As the following text describes, this embodiment uses a series of calculations and interrelated profiles to push products or services to the user. The structure and content of the hypermedia environment may be divided into three categories: structural, contextual, and objective. Elements within these categories may be pre-positioned for retrieval from a users' computer hard drive, portable storage media, or transferred on-demand to the user's computer from a remote server via an Internet connection. Elements related to each category are appropriately coded to allow the program to distinguish among them.

Structural refers to those elements that divide the environment into its conceptual parts and enable the user to navigate from one section to another. These elements may be, for example, menus, controls, and containers.

Contextual elements are the cultural and emotional cues that provide the context within which an object can be understood. These elements may include music, sound effects, graphics packages, animations, and video.

Objective elements are all the objects that live within the hypermedia environment, including products, services and media files.

A present embodiment of the invention may calculate the similarity of objects by first calculating the numerical difference between the individual attributes of the Companion Profile and the Target Profile (expressed always as positive numbers). The program then adds all of these differences together and tags the object with the result. The results will be whole numbers between 0 and 140, where 0 is “Most Desirable” and 140 is “Least Desirable.” Desirable objects may then be “pushed towards” or “made obvious” to the user, while undesirable objects may be “pushed away” or “hidden” from the user. This process is performed first for the structural elements, then for the objective elements, and finally for the contextual elements. The process results in a unique hypermedia experience for each user.

Shopping is rarely just an individual experience. Therefore, a preferred embodiment of the present invention will connect users together over the Internet to enable them to share the shopping experience. Displays may be divided into two or more section, showing the location and activities of other users within the group. Users may shop in, or explore, different areas of the same store. Users may also interact with one store, while other users interact with another store. While in the collaborative shopping mode, all users within the group may observe the interactions of the other users.

In addition, users may chose to “swap” screens, and/or profiles to enable one user to experience a particular environment as if they were the other user.

Users can communicate with other users through a variety of communication methods. An embodiment of the invention may include a variety of advanced user tools, including instant messaging, email, voice, and search. An embodiment of the system may locate anyone or anything connected to the hypermedia network and may make it available to the user. It may communicate directly with users via mobile phones, PDAs, and ambient devices by sending information and alerts related to products, people, and events on the hypermedia network.

The invention lays the path for future compatibility, establishing the building block for an ever-expanding catalog of hypermedia publications. Future hypermedia titles will qualify as “Multi-Spatial Similarity Matrix Compatible.” The more time a user spends navigating these environments, the more effective the matrix becomes.

In an embodiment of the present invention, users will be able to access and control basic functions of the matrix program, for the purpose of changing aspects of their profiles, turning off certain profiling functions, or creating alternate profiles to further customizing their shopping experience. Users also may choose to “opt-out” of the matrix system and shop using a neutral “default” profile.

In an embodiment of the present invention, a Hypercart, or shopping cart, and a shopping system 100 are envisioned. The Hypercart, as graphically represented by element 965 in FIG. 7K, functions seamlessly with the interactive catalog, serving as a virtual wallet, storing personal and financial information, and tracking and recording user actions. A secure remote server houses the actions for later retrieval. Remote storage permits portability, meaning the information can be reloaded onto any interactive catalog with the Hypercart. A user may manipulate business objects, for example, product category, product, and product image by viewing shopping objects, adding or removing shopping objects, updating quantity of any shopping object, estimating and viewing shipping costs, estimating and viewing sales tax, checking out from the shopping cart, entering credit card information during the checkout process, entering shipping and billing address, or confirming or aborting the checkout transaction. An embodiment of the invention may be capable of informing a user of a transaction's success or fail status, accepting credit or debit cards, providing multiple shipping options, performing order and inventory management, calculating taxes, verifying, validating and processing credit or debit cards, eChecks, cash-on-delivery (COD) orders, processes phone, fax and email orders, and storing a complete history of all user actions with each catalog.

This embodiment of the shopping system may provide catalogs of products or services for sale customized for the user. Catalog titles are intelligent in the sense that they may be able to alter their user interface and presentation based on the purchase history and personal preferences of each user as tracked by the Hypercart and analyzed by the system. The system can make specific product recommendations, alter the graphical interface, change content and essentially redecorate, and rearrange itself to appeal to a particular user. A communications hub may facilitate real-time communication between on-line users, administrators, and retailers via instant messaging, email, webcams, including audio. An embodiment of the invention may permit users to quickly access their information by tying user accounts to a specially designed, hand-held navigation controller.

The hypermedia presentation may include virtual sales personalities that can walk a user through a product demonstration up to the purchase of the product. In addition, the predetermined event sequences may be arranged in the form of a story or game centering on the product or service presented for sale. Video content may be provided by a custom application capable of streaming or decoding any of the popular formats, which may be AVI, MP3, and MOV, for example. (Video content may convey information about shopping objects, including but not limited to products and services in the catalogs. The video content may include additional entertainment elements that may include interviews, infomercials, commercials, entertainment, and music videos,

In lieu of a customized application, off-the-shelf applications, which may include Window Media Player®, QuickTime®, and similar applications, may be integrated with the system. For example, an advantage of integrating QuickTime® into a client running on a user's computing system is that the video frames, for example, the frames shown in FIGS. 7A through 7L, may be “wired,” that is, manipulated by user input from a joystick, or other input device. The wired frames allow a user to have random access to the hypermedia frames. For example, as shown in FIG. 7A, a motion picture loop, which may have several hypermedia frames representing a LOGIN page 800, may be presented to the user. Background music may also accompany the motion picture loop. The LOGIN page 800 may have a moving background 802, a username, and password entry area 805, a user ID confirmation block 810, and a service provider identifying icon or logo 812. After the user inputs the correct username and password, the system performs an authentication, and, as shown in FIG. 7B, subsequently, the presentation advances to a continuation set of video frames to display additional information, including user information block 814, user photo ID area 816, and user action prompt field 818.

Now referring to FIG. 7C, as the video frames advance, additional information is provided in the form of a shop now button 820, and a press start prompt 822. Referring to FIG. 7D, it should be noted that subsequent to the user activating a session by pressing start in the previous frame in FIG. 7C, elements of the video presentation, including login entry area 805, user photo ID area 816, confirmation block 810, user info block 814, user action prompt field 818, and the shop now button 820, all dynamically move, (in one embodiment shown, they shrink to a focal point in the background 802) to indicate that a shopping session is about to begin. In addition, an action indicia, for example, the directive “GO!” may be displayed in login entry area 805.

Referring to FIGS. 7D through 7E, there may be provided a transition between frames, for example, a cross-fade, or other visual effect, while indicia 830 is presented to inform the user that a new store is being loaded. A new background pattern 828 may also be displayed. A new music sequence may also be presented at this time. The new music sequence may also be introduced by a cross-fade or other audio effect.

Referring to FIG. 7F, as the video sequence advances, a welcome frame may be presented in which welcoming indicia 840 from the merchant's store is presented. A new foreground image 835 may also be presented. Now referring to FIG. 7G, a product category menu frame 870 (see also FIG. 7H) is presented in which a merchant logo 860 may be displayed in an upper left-hand corner of the frame. Product category selection menus 850 may be displayed in a central left-hand side of the frame, while a product action image 855 may be displayed in a central right-hand side of the frame. The product category selection menus 850 may dynamically transition into their final presentation position. The video transitioning of the product category selection menus 850 may be accompanied by accents in an associated musical or other audio presentation.

Once the user selects a product category, for example, Men's Equipment, as shown in FIG. 7G, the video presentation advances to a product select frame 870, as shown in FIG. 7H, which includes a merchant logo 860 displayed in the upper left-hand corner of the frame. The transition to the product select frame 870 may take place through a cross-fade, intermediate image frames, or other visual effects designed to psychologically prepare the user for an emotionally fulfilling shopping experience. Complementary musical accompaniment transitions are provided, and preferably have musical accents that emphasize dynamic motion of the product displays 875 into a predetermined resting place in the product select frame 870.

The user may cause the reverse and advance in order to select other products, other product categories, or other merchants. Upon user selection of a product from a product select frame, for example, the product select frame 870, the video frames advance to a selected product display frame 870, as shown in FIG. 7I. The selected product display frame 870 may have a product action panel 885. Additionally, a merchant logo 860 is displayed in the upper left-hand portion of the frame. The product action panel 885 may have menu items from which the user may select for additional product information or to purchase the product. FIG. 7I shows the status of the selected product display frame 870 after the user has selected a purchase product menu button (not shown). The product selected for purchase 890 may be displayed in a central left hand portion of the selected product display frame 870. A shopping cart progress panel 895 is displayed subsequent to user selection of the purchase product menu button.

In the preferred embodiment, shopping includes, but is not limited to, shopping cart, billing & shipping, and complete, or confirmation 930 phases. As shown in FIG. 7J, a purchase confirmation frame 900 is displayed during the confirmation phase 930. A cross-fade or intermediate informational frames may be provided to effect the transition from the selected product display frame 980 of FIG. 7L to frame 900. The intermediate informational frames may indicate, for example, a successful transaction status, a shopping complete status, a review of all purchases made including a list of all of the merchants where the user shopped. The purchase confirmation frame 900 may display a progress icon 910 in an upper right-hand portion of the frame. A purchase confirmation activity field 920 is displayed in an upper portion of the frame and may indicate a confirmation phase 930. A purchase information detail panel 950 may be presented that displays shipping information, and the total cost of all purchases during the session. A message confirming the order may be displayed at 940. Upon termination of the shopping session, a shopping cart frame 960 is presented for display. The shopping cart frame 960 may dynamically move for a predetermined number of video frames until it comes to a final resting point.

As shown in FIG. 7K, the shopping cart 965 is shown in the shopping cart frame 960, and contents of the cart 970 may also be shown. The shopping cart frame 960 may then fade or otherwise transition with subsequent image frames leading into service provider notification page 980, as shown in FIG. 7L. Service provider notification page 980 reminds the user of the provider of shopping system 100, and may have a service provider logo 990 as well as other indicia of the service provider, such as service provider name 995.

According to the present embodiment, user profiles may be multi-layered. The user profile can be created by each person with an account in the system. Profiles have multiple levels of access including a public profile, usable as a business card, a storefront, or for the purpose of attracting a mate. Public profiles are searchable based on a variety of criteria.

A further embodiment of the invention contemplates users who become “merchants” may have the capability to build hypermedia stores of their own. These stores may be accessible by users on the matrix network.

In other embodiments of the present invention, users may design their own jewelry; design, build, and purchase customized furniture and cabinetry; customize homes, buildings, landscaping, automobiles and boats; users may book vacations; publish their own hypermedia publications, such as books, graphic novels or video based stories; users may track global conflicts, politics, health information, demographics; or communicate with other users worldwide.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries among various components, operations, and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

What is claimed:

1. A system comprising:
at least one shopper profile stored in a database, the shopper profile representing shopper-pertinent information by measuring attributes of personality and demography;
at least one target profile stored in a database, the target profile denoting potential desirability of a given shopping object to a shopper; and
a hypermedia store presenting interactive challenges to evoke information about a shopper to build the shopper profile and presenting shopping objects available for purchase that are selected based on the target profile and the shopper profile.

2. The system of claim 1, wherein the shopper profile is modified in accordance with purchases made or shopping objects reviewed through the hypermedia store.

3. The system of claim 1, wherein the target profile is modified in accordance with shopper activity, where the shopper activity includes at least one of reviewing a shopping object and purchasing a shopping object.

4. The system of claim 1, further including a virtual shopping cart for storing information pertaining to shopping objects selected from the hypermedia store.

5. The system of claim 1, wherein the hypermedia store presents dynamically layered graphical menus using media objects to provide information displays and navigable links to additional menus, displays, or files.

6. The system of claim 1, wherein the hypermedia store is a computer program embedded in a computer-readable medium, the computer program providing seamless real-time interactivity to facilitate e-commerce in a hypermedia environment.

7. The system of claim 6, wherein the computer program includes at least one of virtual sales personnel and product demonstrations.

8. The system of claim 1, wherein the interactive challenges are video games designed to determine personality characteristics of a game player.

9. The system of claim 1, further comprising a browser for browsing the hypermedia store.

10. The system of claim 1, wherein the shopper profile is comprised of a numerical code that measures a relationship between content of the hypermedia store and a shopper, where each digit of the numerical code is a measure of a specific shopper attribute.

11. The system of claim 10, wherein the shopper attributes are divided into demographic information and dimensions of personality.

12. The system of claim 10, wherein the shopper attributes are measured on a scale of 0 to 9.

13. The system of claim 1, further comprising a structural profile is stored in a database, the structural profile containing objects that represent an environment of the hypermedia store and how the user has modified the environment for use, wherein the structural profile is modified in accordance to at least one of the shopper profile and the target profile.

14. The system of claim 13, further comprising a contextual profile, the contextual profile storing contextual objects which represent visual and audio of the hypermedia store environment, wherein the contextual profile is modified in accordance with at least one of the shopper profile and the target profile.

15. A method for facilitating e-commerce in a hypermedia environment, comprising:
providing interactive challenges in a hypermedia environment, where the challenges gather information about a shopper;
creating a shopper profile representing shopper pertinent information by measuring attributes of personality and demography, the attributes determined in part based on the interactive challenges;
storing a target profile denoting potential desirability of a given shopping object to a shopper; and
presenting at least one shopping object based on a correlation between the shopper profile and the target profile.

16. The method of claim 15, further comprising updating the target profile in accordance with the shopper profile and updating the shopper profile in accordance with the target profile.

17. The method of claim 15, further comprising modifying the shopper profile in accordance with purchases made or shopping objects reviewed in the hypermedia environment.

18. The method of claim 15, further comprising modifying the target profile in accordance with shopper activity, where the shopper activity includes at least one of reviewing a shopping object and purchasing a shopping object.

19. The method of claim 15, storing information pertaining to shopping objects selected from the hypermedia store in a virtual shopping cart.

20. The method of claim 15, further comprising presenting dynamically layered graphical menus using media objects to provide information displays and navigable links to additional menus, displays, or files.

21. The method of claim 15, wherein the interactive challenges are video games designed to gauge personality characteristics of a game player.

22. The method of claim 15, wherein the shopper profile is comprised of a numerical code that measures a relationship between content of the hypermedia environment and a shopper, where each digit of the numerical code is a measure of a specific shopper attribute.

23. The method of claim 15, wherein the shopper attributes are divided into demographic information and dimensions of personality.

24. The method of claim 23, wherein the shopper attributes are measured on a scale of 0 to 9.

25. The method of claim 15, further comprising storing a structural profile in a database, the structural profile containing objects that represent the hypermedia environment and how a shopper has modified the environment for use, wherein the structural profile is modified in accordance at least one of the shopper profile and the target profile.

26. The method of claim 25, further comprising storing a contextual profile, the contextual profile storing contextual objects that represent visual and audio of the hypermedia environment, wherein the contextual profile is modified in accordance with at least one of the shopper profile and the target profile.

27. A computer readable medium storing a program for facilitating e-commerce in a hypermedia environment, the program comprising:
presenting interactive challenges in a hypermedia environment, where the challenges gather information about a shopper;
creating a shopper profile representing shopper pertinent information by measuring attributes of personality and demography, the attributes determined in part based on the interactive challenges;
storing a target profile denoting potential desirability of a given shopping object to a shopper; and
presenting at least one shopping object based on a correlation between the shopper profile and the target profile.

28. A method of claim 15 wherein a user may collaborate with a group using voice, text and video, interacting with multiple users simultaneously to share the shopping experience.
